(19) United States
(12) Patent Application Publication
(10) Pub. No.: US 2009/0055455 A1
(43) Pub. Date: Feb. 26, 2009

(54) MICROPROCESSOR

(75) Inventors: Hideki Matsuyama, Kawasaki (JP); Masayuki Daitou, Kawasaki (JP)

Correspondence Address: YOUNG & THOMPSON, 209 Madison Street, Suite 500, ALEXANDRIA, VA, 22314, US

(73) Assignee: NEC ELECTRONICS CORPORATION, KAWASAKI (JP)

(21) Appl. No.: 12/194,559

(22) Filed: Aug. 20, 2008

(30) Foreign Application Priority Data
Aug. 22, 2007 (JP) 2007-215777

(51) Int. Cl. G06F 17/10

(52) U.S. Cl. 708/231

(57) ABSTRACT

A microprocessor has an instruction decode portion, a register file, a complex operation unit, and a data storage position determining mechanism. The complex operation unit performs complex operation, including complex multiplication, using first and second complex number data supplied from the register file based on an instruction decoded by the instruction decode portion, and outputs the result of the complex operation toward the register file. Furthermore, the data storage position determining mechanism determines the storage positions of the real part and imaginary part of output data of the complex operation unit in the register file such that the storage order of the real part and imaginary part of the output data in the register file is consistent with the storage orders of the real parts and imaginary parts of the first and second complex number data.

### BACKGROUND OF THE INVENTION

1. Field of the Invention

The present invention relates to a microprocessor that performs complex operations including complex multiplications such as Fast Fourier transform (FFT) and Inverse Fast Fourier Transform (IFFT).

2. Description of Related Art

There have been various proposals to make microprocessors perform FET calculations and IFFT calculations efficiently. For example, an online manual titled “Complex Fixed-Point Fast Fourier Transform Optimization for AltiVec™” publicized by Freescale Semiconductor, Inc. on the Internet (URL: http://www.freescale.com/files/32bit/doc/app_note/AN2114.pdf) discloses an example of programs to cause a processor, adopting SIMD (Single Instruction Multiple Data) architecture capable of carrying out batch processing of 128-bit data, to perform Decimation In Frequency (DIF) type FFT calculations.

Furthermore, Japanese Patent Translation Publication No. 2002-527808 discloses a technique in which a complex multiplication unit capable of carrying out multiplication of two complex numbers (complex multiplication) is arranged in a microprocessor using SIMD architecture, and the complex multiplication unit has special instructions that are defined to carry out complex multiplication, and so that FET calculation involving a lot of complex multiplications can be effectively performed by using those special instructions.

FIG. 18 shows the structure of an equivalent complex multiplication unit 70 to the complex multiplication unit disclosed in Japanese Patent Translation Publication No. 2002-527808. The complex multiplication unit 70 in FIG. 18 reads two complex numbers X and Y stored in registers R3 and R4 respectively, and outputs a complex number Z obtained by the multiplication of the complex numbers X and Y to a register R5. The registers R3 and R4, which store input data, and the register R5, which is the destination register in the complex multiplication unit 70, are designated by the operands of the complex multiplication instruction.

More specifically, four multipliers 700-703 calculate the product of the real part X_{R} of X and the real part Y_{R} of Y, the product of the imaginary part X_{I} of X and the imaginary part Y_{I} of Y, the product of the real part X_{R} of X and the imaginary part Y_{I} of Y, and the product of the imaginary part X_{I} of X and the real part Y_{R} of Y, respectively. The calculation results of the multipliers 700-703 are retained in pipeline latches 710-713, respectively.

Then, a subtracter 721 calculates the difference between X_{R}Y_{R} retained in the register 713 and X_{I}Y_{I} stored in the register 712. An adder 720 calculates the sum of X_{R}Y_{I} stored in the register 711 and X_{I}Y_{R} stored in the register 710. That is the calculation result of the subtracter 721 becomes the real part Z_{R} of the output Z outputted after the complex multiplication. Furthermore, the calculation result of the adder 720 becomes the imaginary part Z_{I} of the output Z outputted after the complex multiplication.

Incidentally, when the register length of each of the registers R3-R5 is 32 bits and each of the complex number data X and Y has 16-bit length, the calculation result in the complex multiplication unit 70 must have 32-bit length in order to maintain the arithmetic precision of the complex multiplication. Therefore, a rounding circuit 731 rounds the 32-bit output Z_{R} of the subtracter 721 to 16 bits, and stores it in the lower 16 bits of the register R5. Furthermore, a rounding circuit 730 rounds the 32-bit output Z_{I} of the adder 720 to 16 bits, and stores it in the higher 16 bits of the register R5.

Incidentally, target complex number data of the FFT calculation are stored in data memory (not shown), and read out from the data memory into the registers of the microprocessor so that they are supplied to the complex operation unit such as the complex multiplication unit 70. Furthermore, the target complex number data of the FFT calculation may often be generated by various sensors or image processing devices such as an image pickup device and a microphone. In general, the storage order of the real part and imaginary part of complex number data generated by such devices may be different among the devices.

The inventors have found out that when a complex operation unit to carry out complex multiplication such as the above-described complex multiplication unit 70 is provided in a microprocessor, there are a lot of restrictions on the hardware for the storage order of the real part and imaginary part of input complex number data, and redundancies brought in the software by such restrictions are problematic.

As an example, assume a case where the storage orders of the real parts and imaginary parts of the complex number data X and Y stored in the registers R3 and R4 in the complex multiplication unit 70 shown in FIG. 18 is opposite to the storage order shown in FIG. 18. That is, assume a case where the real parts X_{R} and Y_{R} are stored in the higher bits of the registers R3 and R4 respectively, and the imaginary parts X_{I} and Y, are stored in the lower bits of the registers R3 and R4 respectively.

In general, the adding function and subtracting function, including the direction of the subtraction, of the adder 720 and subtracter 721 are selectable with mode settings and instruction types. However, when the data retained in the registers R3 and R4, in which the storage order of the real part and imaginary part is reversed, is inputted in and calculated by the complex multiplication unit 70, the real part Z_{R} of Z appears at the output of the rounding circuit 731 and the imaginary part Z_{I} of Z appears at the output of the rounding circuit 730 in the same way as the previous case where the storage order of the real part and imaginary part is not reversed.

Therefore, to maintain the consistency of the storage order of the real part Z_{R} and imaginary part Z_{I} in the register R5 with the storage orders of the input registers R3 and R4, the positions of the real parts and imaginary parts of the complex number data retained in the registers R3 and R4 need to be replaced with each other before the operations by the complex multiplication unit 70, or the positions of the real part and imaginary part of the data retained in the register R5 need to be replaced with each other after the operations by the complex multiplication unit 70. Alternatively, the positions of the real parts and imaginary parts of the complex number data retained in the data memory (not shown) need to be replaced with each other before the complex number data are read into the registers R3 and R4. Redundant instructions must be executed in order to carry out the process necessary to replace the data positions in these registers or in the data memory.

### SUMMARY

In accordance with a first aspect of the present invention, a microprocessor includes an instruction decode portion, a register file, a complex operation unit, and a data storage position determining means. The complex operation unit performs complex operation, including complex multiplication, by using first and second complex number data supplied from the register file based on an instruction decoded by the instruction decode portion, and outputs the result of the complex operation toward the register file. Furthermore, the data storage position determining means determines the storage positions of the real part and imaginary part of the output data of the complex operation unit in the register file such that the storage order of the real part and imaginary part of the output data in the register file is consistent with the storage orders of the real parts and imaginary parts of the first and second complex number data.

Incidentally, one example of a specific structure corresponding to the data storage position determining means is shown as selectors 1490 and 1491 in the first embodiment, which is explained later. Furthermore, another example of the specific structure corresponding to the data storage position determining means is shown as a data select circuit 26 in the second embodiment, which is also explained later.

In this manner, in the microprocessor in accordance with the first aspect of the present invention, the data storage position determining means determines the storage positions of the real part and imaginary part of the output data in the register file such that the storage order of the real part and imaginary part of the output data is consistent with the storage orders of the real parts and imaginary parts of the first and second complex number data. That is, the microprocessor in accordance with the first aspect can change the storage order of the real part and imaginary part of the complex number data outputted from the complex operation unit based on the storage orders of the real parts and imaginary parts of the first and second complex number data, even if the storage orders of the real parts and imaginary parts of the first and second complex number data in the register file are reversed. Therefore, restrictions on the hardware for the storage order of the real part and imaginary part of input complex number data can be minimized, and there is no need for the redundant processing necessary to replace the real part and imaginary part in the microprocessor in accordance with the first aspect.

In accordance with a second aspect of the present invention, a microprocessor includes an instruction decode portion, a register file, and a complex operation unit. The register file has first to third registers. The first register can store the real part and imaginary part of a first complex number data, and second register can store the real part and imaginary part of a second complex number data in the same order as the first register. The complex operation unit performs complex operation using complex number data supplied from the register file based on an instruction decoded by the instruction decode portion, and outputs the result of the complex operation toward the third register. Furthermore, the complex operation unit has a complex multiplier to perform complex multiplication by first and second Multiply-Add (MADD) operation circuits, each of which is capable of carrying out a series of MADD operations, and a first select circuit to change the output destination of each of the first and second MADD operation circuits between a first area and a second area adjacent to the first area of the third register.

The microprocessor having such structure in accordance with the second aspect of the present invention can change the output destination of each of the first and second MADD operation circuits, which perform complex multiplications, between the first area and the second area of the third register. That is, the microprocessor in accordance with the second aspect can easily reverse the array order of the real part and imaginary part of the complex number data stored in the third register after the complex multiplication based on the storage orders of the real parts and imaginary parts in the first and second registers.

In accordance with a third aspect of the present invention, a microprocessor includes an instruction decode portion, a register file, a complex operation unit, a storage area select circuit, and a control circuit. The register file has first to third registers. The first register can store the real part and imaginary part of a first complex number data, and second register can store the real part and imaginary part of a second complex number data in the same order as the first register. The complex operation unit performs complex operation using complex number data supplied from the register file based on an instruction decoded by the instruction decode portion, and outputs the result of the complex operation toward the third register. The storage area select circuit changes the storage destination of the output data of the complex operation unit between a first area and a second area adjacent to the first area of the third register. Furthermore, the control circuit controls the operation of the storage area select circuit.

Furthermore, in the third aspect of the present invention, the complex operation unit has a Multiply-Add (MADD) operation circuit, and an input select circuit to change the combination of data input to the MADD operation circuit. The MADD operation circuit can select either a first operation state or a second operation state by the switching operation of the input select circuit. In the description, the first operation state means a operation state in which the multiplication of the first half portion of the first complex number data supplied from the first register and the second half portion of the second complex number data supplied from the second register, the multiplication of the second half portion of the first complex number data and the first half portion of the second complex number data, and the addition or subtraction of the results of these two multiplications are carried out. Meanwhile, the second operation state means a operation state in which the multiplication of the first half portions of the first and second complex number data, the multiplication of the second half portions of the first and second complex number data, and the addition or subtraction of the results of these two multiplications are carried out. Furthermore, the control circuit changes the states of the input select circuit and the storage area select circuit in unison in response to an instruction decoded in the instruction decode portion.

The microprocessor having such structure in accordance with the third aspect of the present invention can generate the imaginary part of the product of the first and second complex number data by the MADD operation circuit configured in the first operation state, and select the output destination of the imaginary part of the product of the first and second complex number data by the storage area select circuit. Furthermore, the microprocessor in accordance with the third aspect can generate the real part of the product of the first and second complex number data by the MADD operation circuit configured in the second operation state, and select the output destination of the real part of the product of the first and second complex number data by the storage area select circuit. That is, the microprocessor in accordance with the third aspect can easily reverse the array order of the real part and imaginary part of the complex number data stored in the third register after the complex multiplication based on the storage orders of the real parts and imaginary parts in the first and second registers.

The above-mentioned first to third aspects in accordance with the present invention can alleviate the restrictions on the storage orders of the real parts and imaginary parts of input data in a microprocessor having a complex operation unit to perform complex operations including complex multiplications. Therefore, it can minimize the increase in redundancy brought in the software by the process necessary to reverse the array order of the real part and imaginary part.

### BRIEF DESCRIPTION OF THE DRAWINGS

The above and other objects, advantages and features of the present invention will be more apparent from the following description of certain preferred embodiments taken in conjunction with the accompanying drawings, in which:

FIG. 1 is a block diagram of a microprocessor in accordance with a first embodiment of the present invention;

FIG. 2 is a block diagram of an instruction execution portion of the microprocessor in accordance with the first embodiment of the present invention;

FIG. 3 shows four-point FFT butterfly computation;

FIG. 4 is a conceptual diagram illustrating the execution procedure of the four-point FFT butterfly computation;

FIG. 5 shows a configuration example of a complex operation unit of the instruction execution portion in accordance with the first embodiment of the present invention;

FIGS. 6A and 6B show the operation logic of an adder-subtractor of the complex operation unit in accordance with the first embodiment of the present invention;

FIG. 7 is a conceptual diagram illustrating the execution procedure of butterfly computation in accordance with the first embodiment of the present invention;

FIGS. 8A and 8B are tables showing the states of the control signals when butterfly computation is performed by the complex operation unit in accordance with the first embodiment of the present invention;

FIG. 9 is a conceptual diagram illustrating the execution procedure of butterfly computation by the complex operation unit in accordance with the first embodiment of the present invention;

FIG. 10 is a block diagram of a microprocessor in accordance with a second embodiment of the present invention;

FIG. 11 is a block diagram of an instruction execution portion of the microprocessor in accordance with the second embodiment of the present invention;

FIG. 12 shows a configuration example of a complex operation unit of the instruction execution portion in accordance with the second embodiment of the present invention;

FIG. 13 is a block diagram of a data select circuit of the microprocessor in accordance with the second embodiment of the present invention;

FIG. 14 is a conceptual diagram illustrating the execution procedure of butterfly computation by the complex operation unit in accordance with the second embodiment of the present invention;

FIG. 15 is a conceptual diagram illustrating the execution procedure of butterfly computation by the complex operation unit in accordance with the second embodiment of the present invention;

FIGS. 16A and 16B are tables showing the states of the control signals when butterfly computation is performed by the complex operation unit in accordance with the second embodiment of the present invention;

FIG. 17 is a conceptual diagram illustrating the execution procedure of butterfly computation by the complex operation unit in accordance with the second embodiment of the present invention; and

FIG. 18 is a block diagram of a complex multiplication unit in the related art.

### DETAILED DESCRIPTION OF THE PREFERRED EMBODIMENTS

The invention will now be described herein with reference to illustrative embodiments. Those skilled in the art will recognize that many alternative embodiments can be accomplished using the teachings of the present invention and that the invention is not limited to the embodiments illustrated for explanatory purposes.

Specific embodiments of the present invention are explained hereinafter with reference to the drawings. In the drawings, the same signs are assigned to the same components, and overlapping explanations for the same components are omitted as appropriate.

### First Embodiment

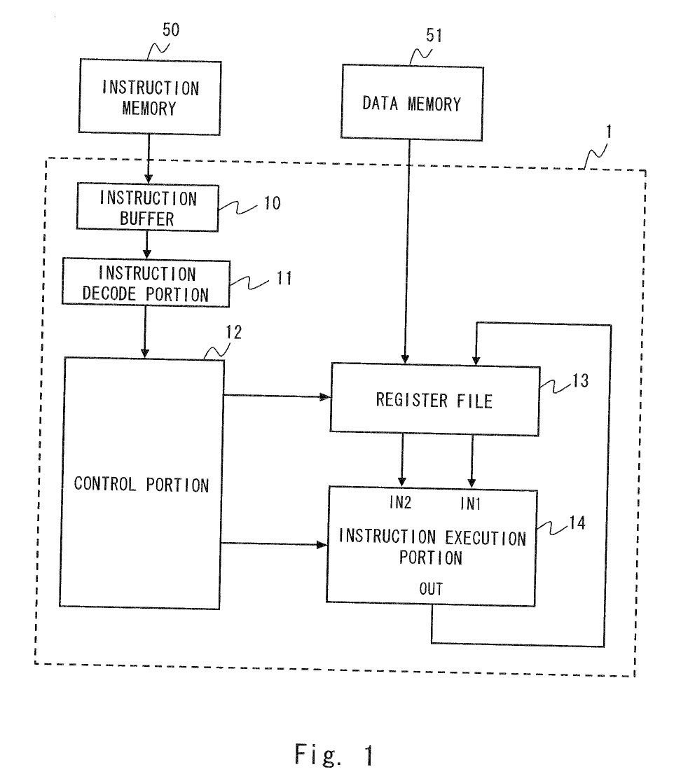

FIG. 1 shows a microprocessor 1 in accordance with this embodiment of the present invention. FIG. 1 is a block diagram illustrating an overall structure of the microprocessor 1. In FIG. 1, an instruction buffer 10 is a temporally storage area to store an instruction fetched from an instruction memory 50. An instruction decode portion 11 reads out an instruction stored in the instruction buffer 10, determines the instruction type of that instruction, and acquires the instruction operands of the instruction. A control portion 12 outputs either data or control signal, or both of them to a register file 13 and an instruction execution portion 14 based on the instruction type and instruction operands obtained by the instruction decoding.

The register file 13 includes a set of plural registers. In this embodiment, the following explanations are made with an assumption that the register file 13 has at least five registers R0-R5. Furthermore, assume that each register in the register file 13 has 64-bit register length. Incidentally, it should be understood that these number and length of registers are just for an illustrative purpose. Registers in the register file 13, including the registers R0-R5, may be used for a variety of purposes, for example, as the accumulator to store an input data and output data of the instruction execution portion 14, or as the address register to address a data memory 51 to make access to the data memory 51.

The instruction execution portion 14 executes a process corresponding to the instruction decoded by the instruction decode portion 11. Specifically, the instruction execution portion 14 has plural operation units, and executes decoded instructions using an appropriate operation unit for each of the decoded instructions under the control of the control portion 12. For example, when an instruction instructing the execution of arithmetic processing such as an addition instruction or a Multiply-Add (MADD) operation instruction is decoded, the instruction execution portion 14 performs the designated arithmetic processing using data supplied from the register file 13. Furthermore, for example, when a load instruction or a store instruction is decoded, the instruction execution portion 14 generates an address of the data memory 51, and accesses to the data memory 51. The instruction execution portion 14 may have dedicated execution unit(s) specialized to specific arithmetic processing such as FFT processing, in addition to a floating-point operation unit, an integer operation unit, a load/store unit, and the like.

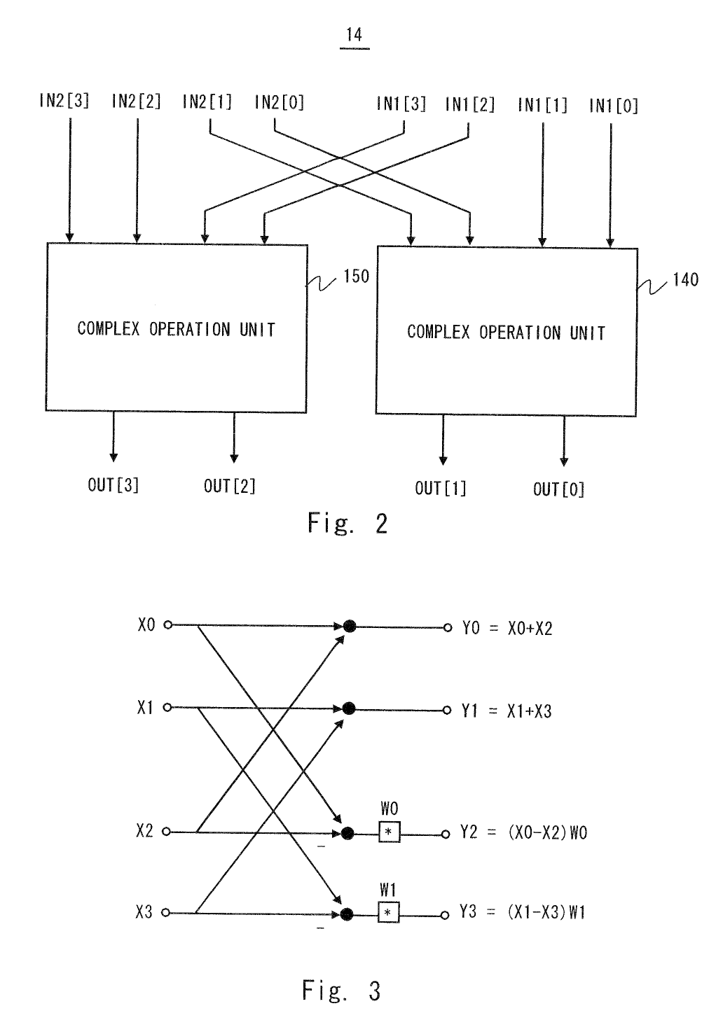

As shown in FIG. 2, the instruction execution portion 14 in accordance with this embodiment has at least two complex operation units 140 and 150. In FIG. 2, IN1[0]-IN1[3] constitute 64-bit data supplied from the register file 13 to IN1 terminal of the instruction execution portion 14, and each of the IN1[0]-IN1[3] has 16-bit length. Similarly, IN2[0]-IN2[3] constitute 64-bit data supplied from the register file 13 to IN2 terminal of the instruction execution portion 14, and each of the IN2[0]-IN2[3] has 16-bit length. OUT[0]-OUT[3] constitute 64-bit data outputted from the instruction execution portion 14 to the register file 13, and each of the OUT[0]-OUT[3] has 16-bit length. The detail of complex operations performed by the complex operation units 140 and 150, and the detail of specific configuration examples of the complex operation units 140 and 150 are explained later.

Incidentally, FIG. 1 shows the instruction memory 50 and the data memory 51 as logical units, but each of these memories is composed of a ROM (Read Only Memory), a SRAM (Static Random Access Memory), a DRAM (Dynamic Random Access Memory), a flash memory, or combination of those devices or the like.

Next, the detail of complex operations performed by the complex operation units 140 and 150, which are contained in the instruction execution portion 14, and the detail of specific configuration examples of the complex operation units 140 and 150 are explained hereinafter. In this embodiment, an example where radix-2 butterfly with regard to four-point complex FFT is performed by the complex operation units 140 and 150 is explained.

FIG. 3 shows the flow graph of radix-2 butterfly computation with regard to four-point complex FFT. Incidentally, FIG. 3 shows an example of Decimation-In-Frequency (DIF)-type butterfly computation. That is, assuming that four input complex number data are X0-X3 respectively, output data Y0 and Y2 are obtained by carrying out butterfly computation using a pair of data X0 and X2. Similarly, output data Y1 and Y3 are obtained by carrying out butterfly computation using a pair of data X1 and X3. The output data Y0-Y3 are expressed by the following equations (1)-(4) respectively. Incidentally, W0 and W1 are twiddle factors.

Y0=X0+X2 (1)

Y1=X1+X3 (2)

Y2=(X0−X2)W0 (3)

Y3=(X1−X3)W1 (4)

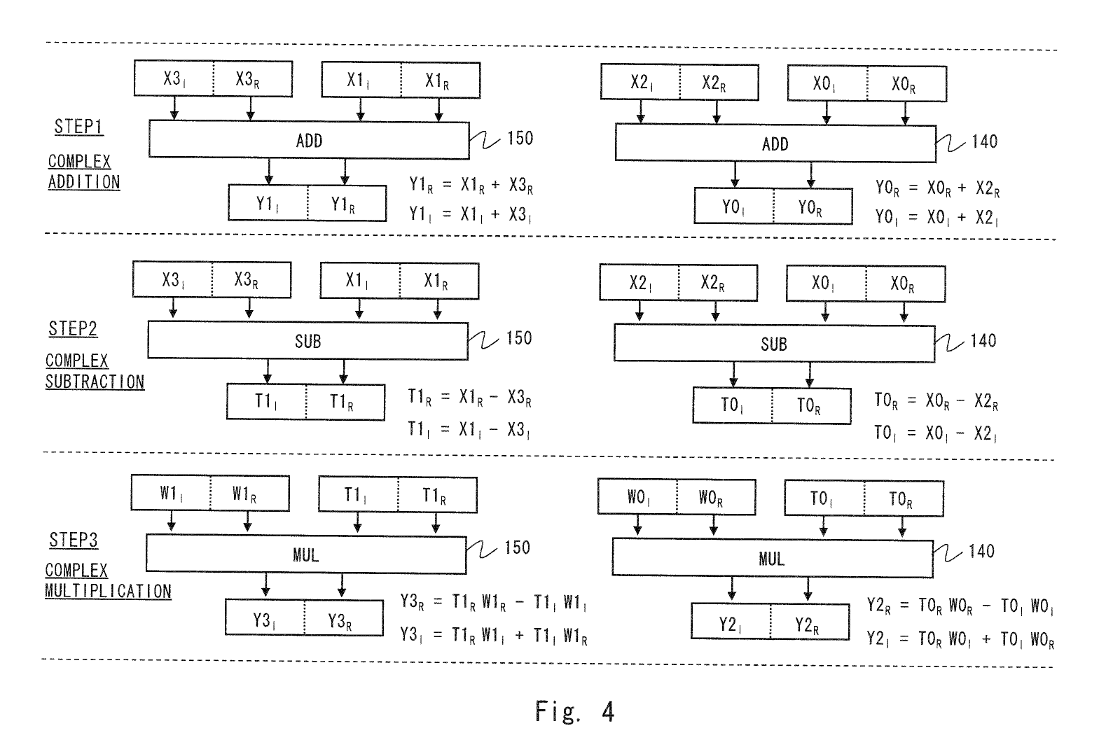

The execution procedure of butterfly computations shown in FIG. 3 by using the two complex operation units 140 and 150 is explained hereinafter with reference to FIG. 4. Firstly, in STEP 1, the complex operation units 140 and 150 performs complex additions corresponding to the equations (1) and (2) in response to the decoding of an addition instruction in the instruction decode portion 11, and outputs Y0 and Y1. Next, in STEP 2, the complex operation units 140 and 150 performs complex subtractions corresponding to the parts of the equations (3) and (4) in response to the decoding of a subtraction instruction, and outputs T0 and T1. T0 and T1 are expressed by the equations (5) and (6) shown below. In STEP 3, the complex operation units 140 and 150 performs complex multiplications of T0 and T1 obtained in the STEP 2 and the twiddle factors W0 and W1 in response to the decoding of a complex multiplication instruction, and outputs Y2 and Y3.

T0=X0−X2 (5)

T1=X1−X3 (6)

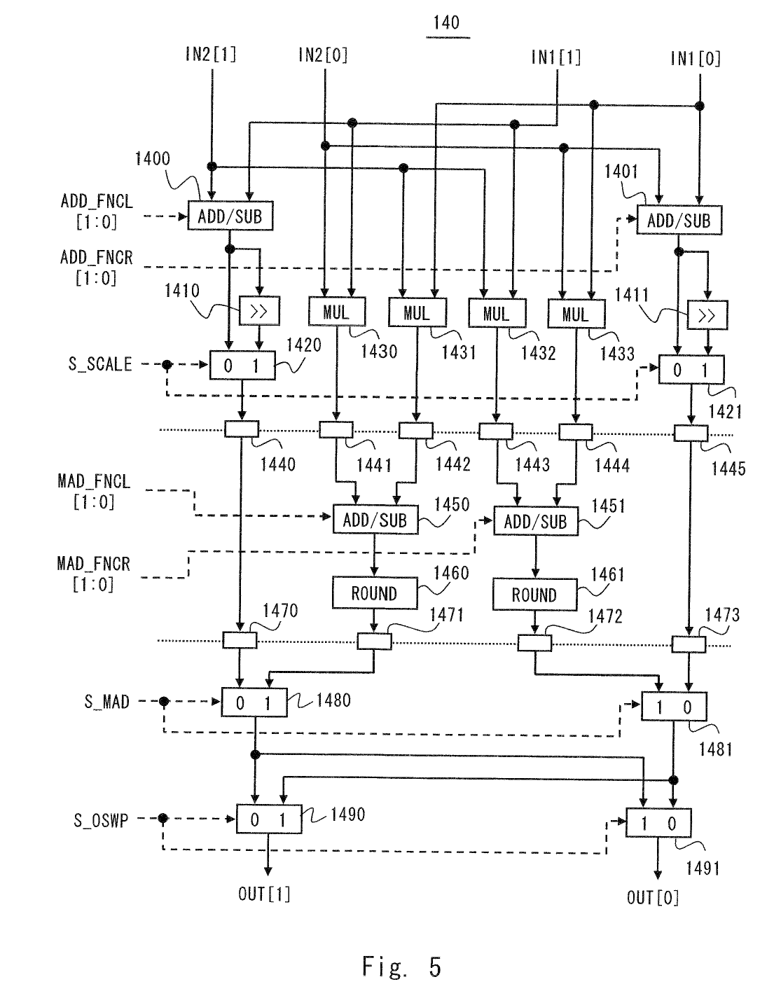

Next, a specific configuration example of the complex operation units 140 and 150 to selectively carry out each process of the complex addition, complex subtraction, and complex multiplication illustrated in FIG. 4 are explained hereinafter. FIG. 5 is a block diagram showing a configuration example of the complex operation unit 140. The complex operation unit 150 may have an identical structure with the complex operation unit 140. The configuration example shown in FIG. 5 adopts a pipeline structure, and each process of the complex addition, complex subtraction, and complex multiplication are carried out in three-stage pipeline processing. Incidentally, the structure of the complex operation unit 140 shown in FIG. 5 is just for an illustrative purpose, and those skilled in the art can conceive various modifications based on FIG. 5 and the following explanations, and common technical information in the art.

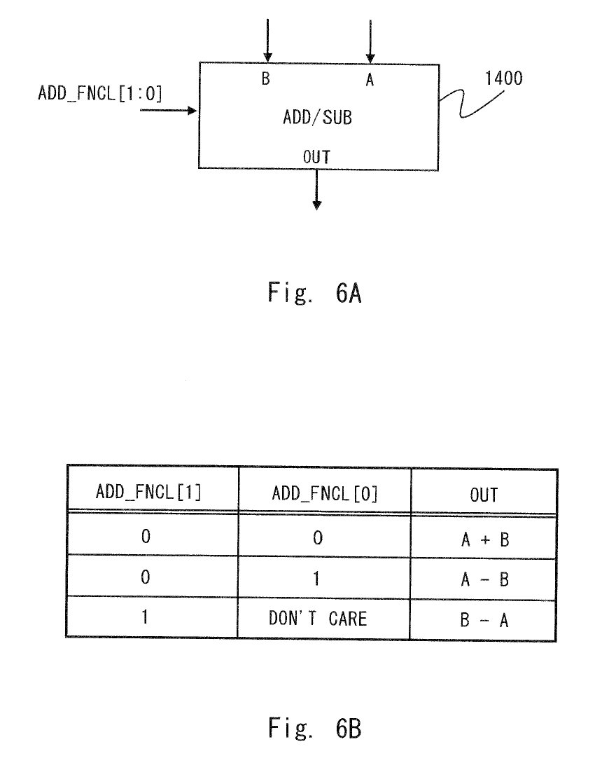

In FIG. 5, an adder-subtractor (ADD/SUB) 1400 carries out addition or subtraction of 16-bit data IN2[1] supplied from the IN2 terminal and 16-bit data IN1[1] supplied from the IN1 terminal. The type of the operation of the ADD/SUB 1400 is controlled by a 2-bit control signal ADD_FNCL[1:0] supplied from the control portion 12. FIGS. 6A and 6B show the operation logic of the ADD/SUB 1400. The ADD/SUB 1400 carries out three types of calculations, i.e., A+B, A−B, and B−A in accordance with the table shown in FIG. 6B.

The ADD/SUB 1401 carries out addition or subtraction of 16-bit data IN2[0] supplied from the IN2 terminal and 16-bit data IN1[0] supplied from the IN1 terminal. Similarly to the ADD/SUB 1400, the type of the operation of the ADD/SUB 1401 is controlled by a 2-bit control signal ADD_FNCR[1:0] supplied from the control portion 12.

A shift circuit 1410 is a circuit to carry out a scaling process to multiply the output from the ADD/SUB 1400 by ½, and shifts the lower 15 bits of the output data of the ADD/SUB 1400 to the right by one bit, and outputs resulting data. A shift circuit 1411 carries out a bit-shift operation similar to that of the shift circuit 1410, to the output from the ADD/SUB 1401.

A selector 1420 receives the output data of the ADD/SUB 1400 and the output data of the shift circuit 1410, and selects and outputs the output data of the ADD/SUB 1400 when a 1-bit control signal S_SCALE supplied from the control portion 12 is “0”, and selects and outputs the output data of the shift circuit 1410 when the 1-bit control signal S_SCALE is “1”.

A selector 1421 carries out a select operation similar to the selector 1420, to the output data of the ADD/SUB 1401 and the output data of the shift circuit 1411. The outputs from the selectors 1420 and 1421 are retained in pipeline latches 1440 and 1445 respectively.

A multiplier 1430 multiplies 16-bit data IN2[0] supplied from the IN2 terminal by 16-bit data IN1[1] supplied from the IN1 terminal. A multiplier 1431 multiplies 16-bit data IN2[1] supplied from the IN2 terminal by 16-bit data IN1[0] supplied from the IN1 terminal. A multiplier 1430 multiplies 16-bit data IN2[1] supplied from the IN2 terminal by 16-bit data IN1[1] supplied from the IN1 terminal. A multiplier 1430 multiplies a 16-bit data IN2[0] supplied from the IN2 terminal by 16-bit data IN1[0] supplied from the IN1 terminal.

The outputs from the multipliers 1430-1433 are retained in pipeline latches 1441 and 1444 respectively. Incidentally, since the outputs from the multipliers 1430-1433 have 32-bit length, the register length of each of the pipeline latches 1441-1444 is at least 32 bits in order to maintain the arithmetic precision.

Next, an ADD/SUB 1450 receives two 32-bit data from the pipeline latches 1441 and 1442, and carries out addition or subtraction of them at the second pipeline stage. Similarly to the ADD/SUB 1400, the type of the operation of the ADD/SUB 1450 is controlled by a 2-bit control signal MAD_FNCL[1:0] supplied from the control portion 12.

Furthermore, an ADD/SUB 1451 receives two 32-bit data from the pipeline latches 1443 and 1444, and carries out addition or subtraction of them. Similarly to the ADD/SUB 1400, the type of the operation of the ADD/SUB 1451 is controlled by a 2-bit control signal MAD_FNCR[1:0] supplied from the control portion 12.

A rounding circuit 1460 rounds the output data of the ADD/SUB 1450 from 32-bits to 16 bits, and outputs it to a pipeline latch 1471 having 16-bit length. Similarly, a rounding circuit 1461 rounds the output data of the ADD/SUB 1451 from 32 bits to 16 bits, and outputs it to a pipeline latch 1472 having 16-bit length.

Pipeline latches 1470-1473 latch the output data from the pipeline latch 1440, rounding circuit 1460, rounding circuit 1461, and pipeline latch 1445.

Incidentally, as can be seen from FIG. 5 and above explanations, the multipliers 1430 and 1431 and the ADD/SUB 1450 constitute a first MADD operation circuit to carry out a MADD operation. Similarly, the multipliers 1432 and 1433 and the ADD/SUB 1451 constitute a second MADD operation circuit to carry out a series of MADD operations. Then, the multiplication of two complex number data can be performed by these two MADD operation circuits.

Finally, at the third pipeline stage, selector 1480 receives the output data of the pipeline latches 1470 and 1471, and selects and outputs the output data of the pipeline latch 1470 when a 1-bit control signal S_MAD supplied from the control portion 12 is “0”, and selects and outputs the output data of the pipeline latch 1471 when the 1-bit control signal S_MAD is “1”. That is, the selector 1480 selects which of the result of the complex addition-subtraction (in the strict sense, either the real part or the imaginary part of the result of the complex addition-subtraction) or the result of the complex multiplication (in the strict sense, the imaginary part of the result of the complex multiplication) is outputted to subsequent circuit.

Furthermore, selector 1481 receives the output data of the pipeline latches 1472 and 1473, and selects and outputs the output data of the pipeline latch 1473 when a 1-bit control signal S MAD supplied from the control portion 12 is “0”, and selects and outputs the output data of the pipeline latch 1472 when the 1-bit control signal S-MAD is “1”. That is, the selector 1481 selects which of the result of the complex addition-subtraction (in the strict sense, either the real part or the imaginary part of the result of the complex addition-subtraction) or the result of the complex multiplication (in the strict sense, the real part of the result of the complex multiplication) is outputted to subsequent circuit.

A selector 1490 receives the output data of the selectors 1480 and 1481, and selects and outputs the output data of the selector 1480 when a 1-bit control signal S_OSWP supplied from the control portion 12 is “0”, and selects and outputs the output data of the selector 1481 when the 1-bit control signal S_OSWP is “1”.

Similarly, a selector 1491 receives the output data of the selectors 1480 and 1481, and carries out an operation similar to the selector 1490. However, the operations of the selectors 1490 and 1491 are complementary to each other. That is, when the selector 1490 outputs the imaginary part of the complex multiplication result, the selector 1491 outputs the real part of the complex multiplication result. Furthermore, when the selector 1490 outputs the real part of the complex multiplication result, the selector 1491 outputs the imaginary part of the complex multiplication result.

That is, selectors 1490 and 1491 are a circuit to reverse the data order of the real part and imaginary part of the complex multiplication result fed to OUT[0] and OUT[1] when the imaginary part of the complex multiplication result is supplied from the selector 1480 and the real part of the complex multiplication result is supplied from the selector 1481.

As described above, in the configuration example shown in FIG. 5, 17-bit length addition-subtraction result, which is obtained by carrying out addition or subtraction of two 16-bit input data in the ADD/SUB 1400, is scaled down by a factor 2 in order to obtain 16-bit length addition-subtraction result. In this manner, it can minimize the deterioration in arithmetic precision in comparison with the case where two input data to the ADD/SUB 1400 are scaled down by a factor 2 before the addition or subtraction is carried out. The same is true for the ADD/SUB 1401.

Furthermore, in the configuration example shown in FIG. 5, the rounding circuit 1460 carries out the rounding process from 32 bits to 16 bits after the ADD/SUB 1450 carries out addition or subtraction of two 32-bit multiplication result data obtained by the multipliers 1430 and 1431. In this manner, it can minimize the deterioration in arithmetic precision in comparison with the case where two 32-bit multiplication result data obtained by the multipliers 1430 and 1431 are rounded to 16 bits before the addition-subtraction of these two multiplication result data is carried out. The same is true for the ADD/SUB 1451 and rounding circuit 1461.

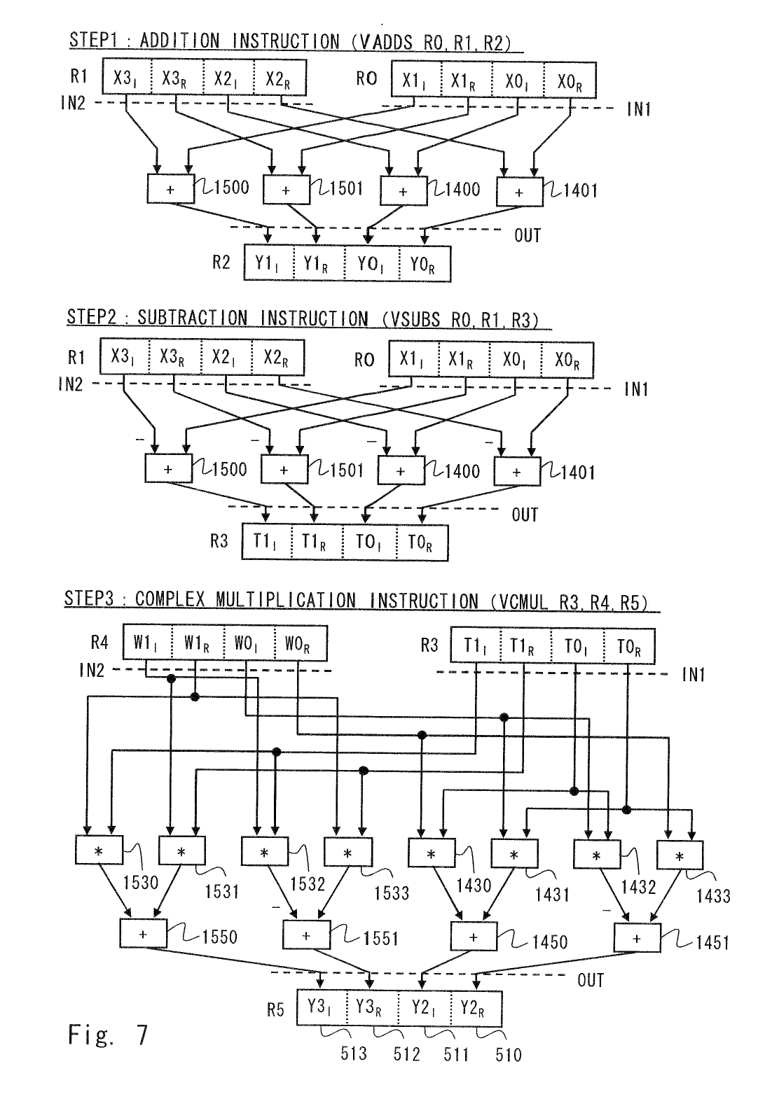

Next, it is explained that the execution procedures of the butterfly computations shown in FIG. 4 executed by the complex operation unit 140 shown in FIG. 5 and the complex operation unit 150 having the same structure as the complex operation unit 140. FIG. 7 shows equivalent diagrams of the STEPs 1-3 shown in FIG. 4, redrawn with specific components of the complex operation units 140 and 150.

Firstly, in STEP 1, the ADD/SUBs 1400, 1401, 1500 and 1501 perform complex additions corresponding to the equations (1) and (2) in response to decoding of the addition instruction (VADDS instruction) in the instruction decode portion 11. The ADD/SUBs 1400, 1401, 1500 and 1501 output the real parts and imaginary parts of Y0 and Y1. The ADD/SUBs 1500 and 1501 are contained in the complex operation unit 150 having an identical structure with the complex operation unit 140, and correspond to the ADD/SUBs 1400 and 1401 respectively. Furthermore, the registers R0 and R1, which are designated by the first and second operands of the VADDS instruction, are used as source registers for the target data of the addition, i.e., the four complex number data X0-X3. Furthermore, the register R2, which is designated by the third operand of the VADDS instruction, is used as the register to which the addition results Y0 and Y1 of the complex operation units 140 and 150 are stored.

In STEP 2, the ADD/SUBs 1400, 1401, 1500 and 1501 perform complex subtractions corresponding to the parts of the equations (3) and (4) in response to decoding of the subtraction instruction (VSUBS instruction), and outputs T0 and T1. The registers R0 and R1, which are designated by the first and second operands of the VSUBS instruction, are used as source registers for the target data of the subtraction, i.e., the four complex number data X0-X3. Furthermore, the register R3, which is designated by the third operand of the VSUBS instruction, is used as the register to which the subtraction results T0 and T1 of the complex operation units 140 and 150 are stored.

In STEP 3, the complex operation units 140 and 150 perform complex multiplications of T0 and T1 obtained in the STEP 2 and the twiddle factors W0 and W1 in response to decoding of the complex multiplication instruction (VCMUL instruction), and outputs Y2 and Y3. Incidentally, the multipliers 1530-1533 and the ADD/SUBs 1550 and 1551 are contained in the complex operation unit 150, and correspond to the multipliers 1430-1433 and the ADD/SUBs 1450 and 1451 respectively. Furthermore, the registers R3 and R4, which are designated by the first and second operands of the VCMUL instruction, are used as source registers for the target data of the complex multiplication, i.e., the four complex number data T0, T1, W0, and W1. Furthermore, the register R5, which is designated by the third operand of the VCMUL instruction, is used as the register to which the complex multiplication results Y2 and Y3 of the complex operation units 140 and 150 are stored.

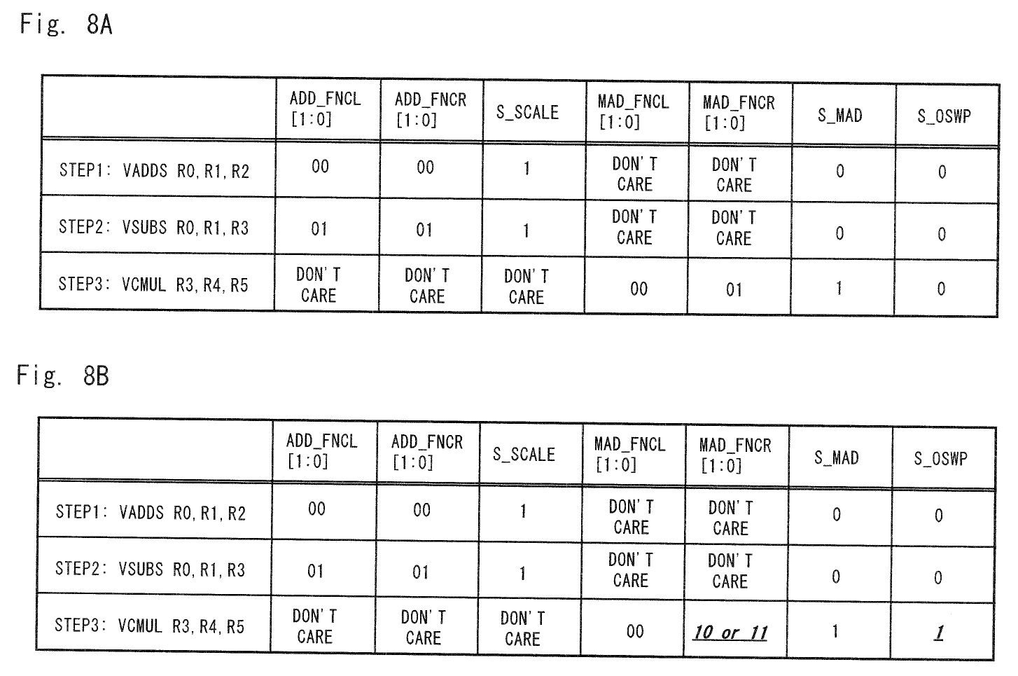

In the execution procedures of STEPs 1-3 shown in FIG. 7, the operations of the plural ADD/SUBs and plural selectors contained in the complex operation units 140 and 150 are controlled by the control signals supplied from the control portion 12 to the instruction execution portion 14. A table in FIG. 8A shows combinations of the control signals supplied from the control portion 12 to the instruction execution portion 14 in response to the decoding of the VADDS, VSUB, and VCMUL instructions shown in FIG. 7.

For example, when the VCMUL instruction is decoded in the STEP 3, the control signal MAD_FNCR[1:0] to the ADD/SUB 1451 is set to “01”, and the control signal S_OSWP to the selectors 1490 and 1491 is set to “0”. Incidentally, the operation logic of the ADD/SUB 1451 is the same as that of the ADD/SUB 1400, which is shown in FIG. 6B. As described above, the selectors 1490 and 1491 are a circuit for reverse the output order of the real part and imaginary part of a complex multiplication result. That is, the control portion 12 can conform the storage orders of the real parts and imaginary parts of the complex multiplication results Y2 and Y3 in the register R5 with the storage orders of the real parts and imaginary parts of the target data X0-X3 of the butterfly computation in the registers R0 and R1 by controlling the operations of the selectors 1490 and 1491 and the corresponding two selectors in the complex operation unit 150.

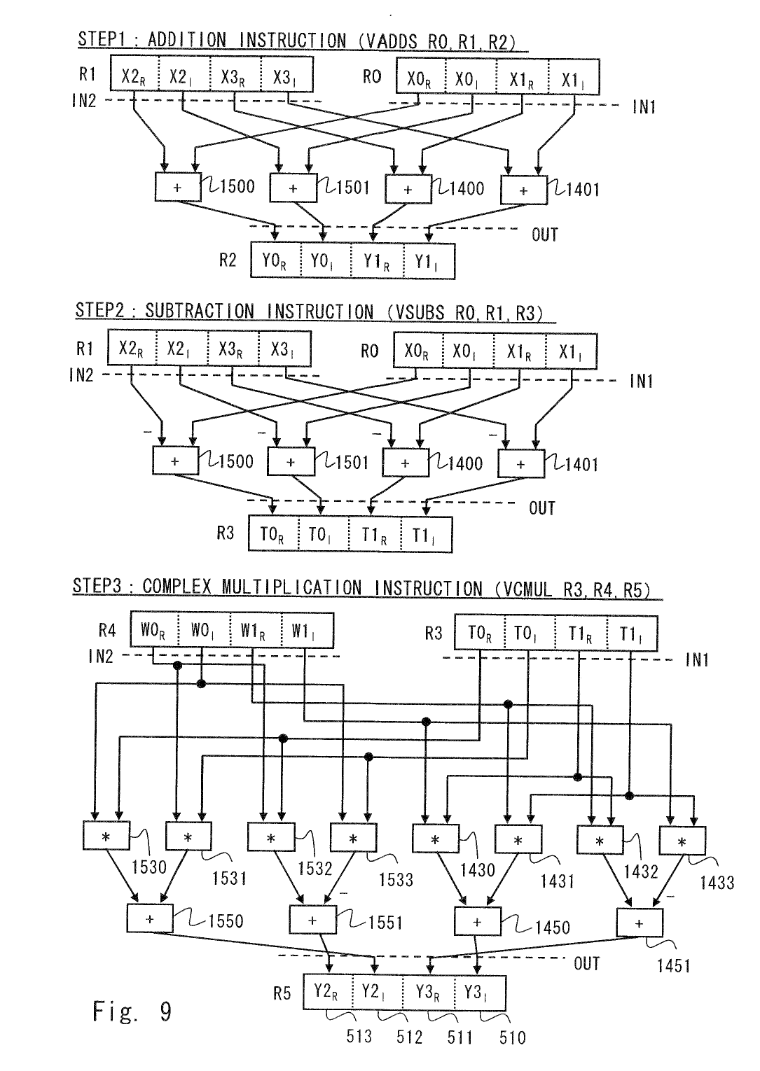

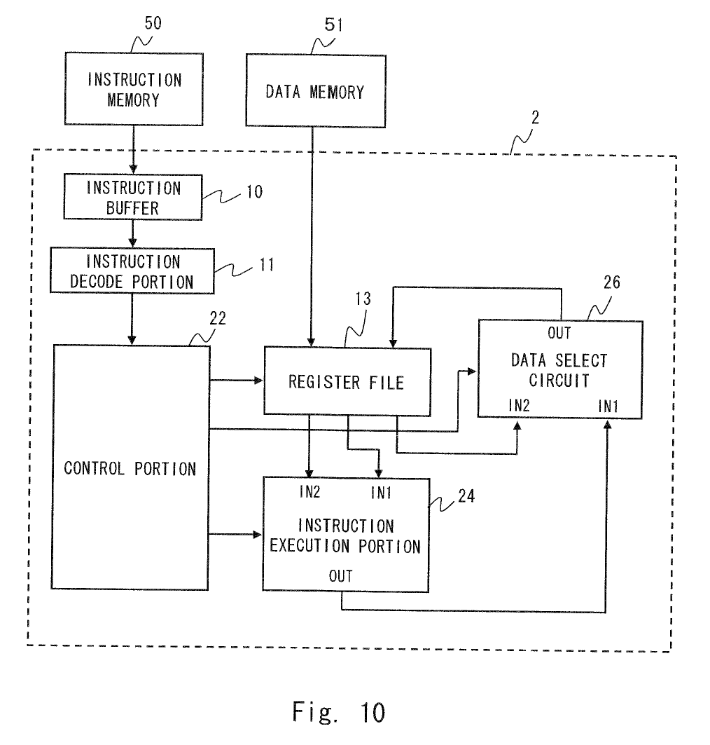

In order to illustrate the advantageous effects achieved by reversing the output order of the real parts and imaginary parts of the complex multiplication results Y2 and Y3 by the selectors 1490 and 1491 and the corresponding two selectors in the complex operation unit 150C FIG. 9 shows another execution procedure of the STEPs 1-3 in which the storage orders of the real parts and imaginary parts of X0-X3 in the register R0 and R1 are opposite to the storage orders shown in FIG. 7.

The directions of the subtractions that are carried out by the ADD/SUBs 1450, 1451, 1550 and 1551 when the complex multiplication instruction (VCMUL instruction) is executed in the STEP 3 are different between the example shown in FIG. 7 and the example shown in FIG. 9. Furthermore, the selections made by the selector 1490 and 1491 and the corresponding two selectors in the complex operation unit 150 (all of them are not shown in FIG. 9) in the execution of the STEP 3 are different between the example shown in FIG. 7 and the example shown in FIG. 9. That is, in the example in FIG. 7, the output from the ADD/SUB 1451 (in the strict sense, the output from the rounding circuit 1461) is stored in the lowest 16-bit area 510 of the register R5, and the output from the ADD/SUB 1450 (in the strict sense, the output from the rounding circuit 1460) is stored in the 16-bit area 511, which is located adjacent to the 16-bit area 511, of the register R5. On the other hand, in the example in FIG. 9, the output from the ADD/SUB 1450 is stored in the lowest 16-bit area 510 of the register R5, and the output from the ADD/SUB 1451 is stored in the 16-bit area 511 of the register R5. Similarly, in FIG. 7, the output from the ADD/SUB 1551 is stored in the 16-bit area 512 of the register R5, and the output from the ADD/SUB 1550 is stored in the highest 16-bit area 513 of the register R5. On the other hand, in FIG. 9, the output from the ADD/SUB 1550 is stored in the 16-bit area 512 of the register RS, and the output from the ADD/SUB 1551 is stored in the 16-bit area 513 of the register R5.

A table in FIG. 8B shows combinations of the control signals supplied from the control portion 12 to the instruction execution portion 14 in response to the decoding of the VADDS, VSUBS, and VCMUL instructions shown in FIG. 9. When the VCMUL instruction is decoded in the STEP 3, the control signal MAD_FNCR[1:0] to the ADD/SUB 1451 is set to “10” or “11”, and the control signal S_OSWP to the selectors 1490 and 1491 is set to “1”.

Incidentally, the instruction code of the complex multiplication instruction is the same throughout FIGS. 7 to 9 regardless of the storage orders of the real parts and imaginary parts of the input data In this case, the values of the control signals MAD_FNCR[1:0] and S_OSWP may be changed by the operation mode setting for the control portion 12. However, the method of changing the selections made by the selectors 1490 and 1491 and the corresponding two selectors in the complex operation unit 150 is not limited to the explained method. For example, two types of complex multiplication instructions may be defined, and the control portion 12 may change the values of the control signals MAD_FNCR[1:0] and S_OSWP based on which of the two types of complex multiplication instructions is decoded.

As described above, the microprocessor 1 in accordance with this embodiment of the present invention has complex operation units 140 and 150 to perform complex operations including complex multiplications. Furthermore, the complex operation units 140 and 150 can change the output order of the real part and imaginary part of the complex multiplication result by the operations of the selectors 1490 and 1491 and the corresponding two selectors in the unit 150. In this manner, the microprocessor 1 can determine the data storage positions of the real parts and imaginary parts of the complex multiplication result data Y1-Y4 such that the storage orders of the real parts and imaginary parts of the complex multiplication result data Y1-Y4 conform with the storage orders of the real parts and imaginary parts of the target data X0-X3 of the complex operation, even if the storage orders of the real parts and imaginary parts of the target data X0-X3 of the complex operation in the data memory 51 or the register file 13 are changed.

Therefore, the restrictions on the hardware for the storage orders of the real parts and imaginary parts of input complex number data are minimized, and there is no need for the redundant processing necessary to reverse the storage order of the real part and imaginary part in the microprocessor 1. Furthermore, it can minimize the increase in redundancy brought in the software by the processing necessary to reverse the array order of the real part and imaginary part.

### Second Embodiment

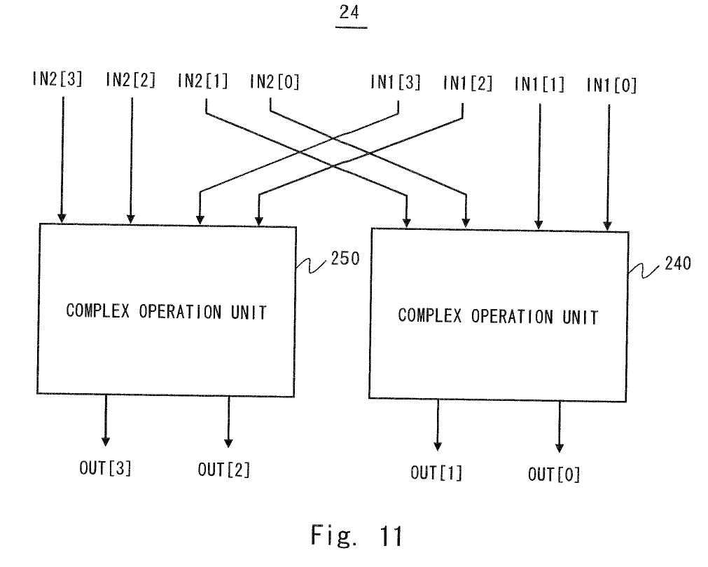

FIG. 10 shows the structure of a microprocessor 2 in accordance with this embodiment of the present invention. In comparison with the above-described microprocessor 1, the structure of the complex operation units contained in the instruction execution portion 24 of the microprocessor 2 is different from that of the instruction execution portion 14. Furthermore, the microprocessor 2 has a data select circuit 26 arranged between the output of the instruction execution portion 24 and the register file 13. The operation of the data select circuit 26 is controlled by a control portion 22.

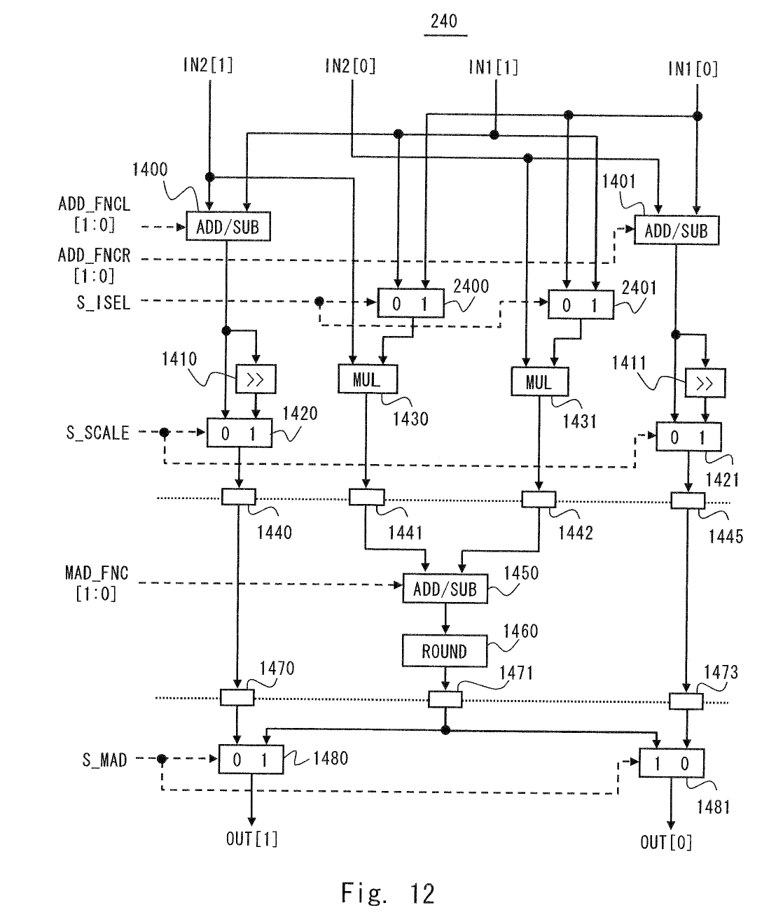

As shown in FIG. 11, the instruction execution portion 24 has at least two complex operation units 240 and 250. FIG. 12 shows a configuration example of the complex operation unit 240. Incidentally, the complex operation unit 250 may have an identical structure with the complex operation unit 240. In the configuration example of the complex operation unit 240 in FIG. 12, the second MADD operation circuit (the multipliers 1432 and 1433 and the ADD/SUB 1450), the rounding circuit 1461, and the pipeline latches 1443, 1444 and 1472 are eliminated in comparison with the complex operation unit 140 shown in FIG. 5. Furthermore, in the configuration example of the complex operation unit 240 in FIG. 12, the selectors 1490 and 1491 are also eliminated.

On the other hand, the complex operation unit 240 has selectors 2400 and 2401 to select input data to the multipliers 1430 and 1431. The selector 2400 receives 16-bit data IN1[0] and 16-bit data IN1[1]. The selector 2400 selects and outputs the IN1[1] when a 1-bit control signal S_ISEL supplied from the control portion 22 is “0”, and selects and outputs the IN1[0] when the 1-bit control signal S_ISEL is “1”. The selector 2401 receives 16-bit data IN1[0] and 16-bit data IN1[1]. The selector 2401 selects and outputs the IN1[0] when a 1-bit control signal S_ISEL is “0”, and selects and outputs the IN1[1] when the 1-bit control signal S-ISEL is “1”.

That is, the selectors 2400 and 2401 operate complementarily with each other, and when one of them selects the data IN1[0], the other of them selects the data IN1[1]. By providing the selectors 2400 and 2401 in the complex operation unit 240, it can selectively carry out two MADD operations, which are carried out in parallel in the complex operation unit 140 shown in FIG. 5, by the first MADD operation circuit composed of the multipliers 1430 and 1431 and the ADD/SUB 1450.

The data select circuit 26 receives 64-bit output data of the instruction execution portion 24. Further the data select circuit 26 receives 64-bit data retained in a register in the register file 13 designated as a storage place for the output data of the instruction execution portion 24. Then, the data select circuit 26 stores 64-bit data obtained by merging these two data in the register designated as the storage place for the output data of the instruction execution portion 24. The data merge process by the data select circuit 26 is carried out in response to a control signal supplied from the control portion 22.

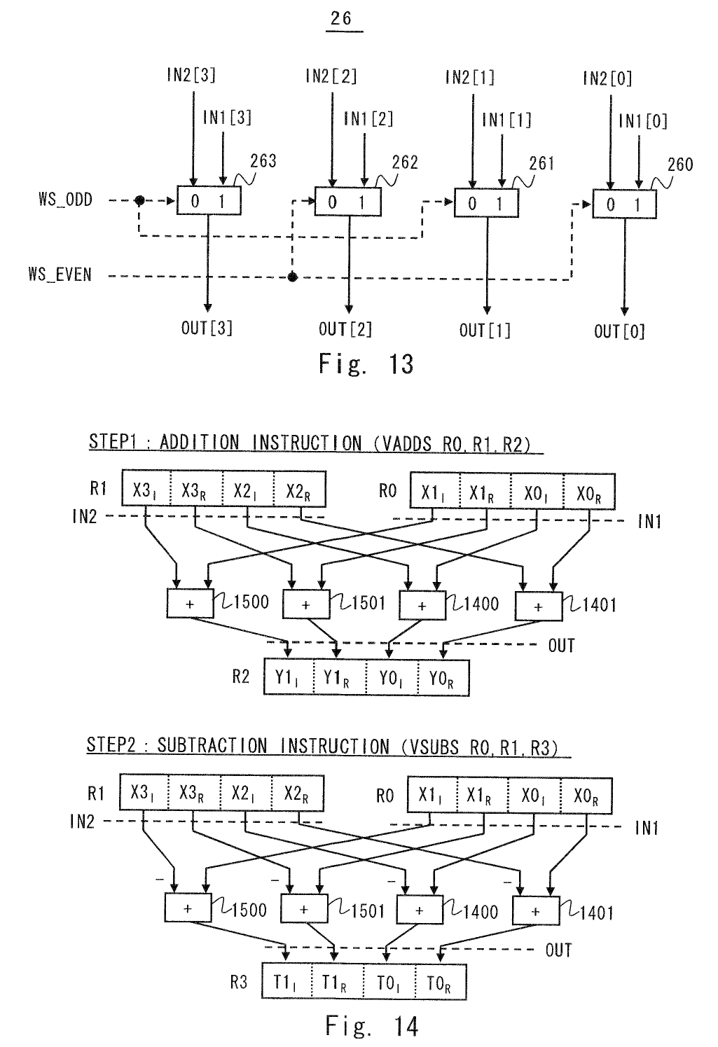

FIG. 13 shows a configuration example of the data select circuit 26. In FIG. 13, IN1[0]-IN1[3] are 64-bit data, which is outputted from the instruction execution portion 24 and supplied to the IN1 terminal of the data select circuit 26, and each of IN1[0]-IN1[3] has 16-bit length. IN2[0]-IN2[3] are 64-bit data, which is supplied from the register file 13 to the IN2 terminal of the data select circuit 26, and each of IN2[0]-IN2[3] has 16-bit length.

A selector 260 receives 16-bit data IN1[0] and 16-bit data IN2[0], and selects and outputs the IN2[0] when a 1-bit control signal WS_EVEN is “0”, and selects and outputs the IN1[0] when the 1-bit control signal WS_EVEN is “1”. A selector 261 receives 16-bit data IN1[1] and 16-bit data IN2[1], and selects and outputs the IN2[1] when a 1-bit control signal WS_ODD is “0”, and selects and outputs the IN1[1] when the 1-bit control signal WS_ODD is “1”. A selector 262 operates in a similar manner to the selector 260 in response to the control signal WS_EVEN, and selectively outputs IN1[2] or IN2[2]. Furthermore, a selector 263 operates in a similar manner to the selector 261 in response to the control signal WS_ODD, and selectively outputs IN1[3] or IN2[3]. When the control signal WS_EVEN and control signal WS_ODD are set to different values from each other, the data select circuit 26 carries out merge process of data retained in the register file 13 and output data of the instruction execution portion 24.

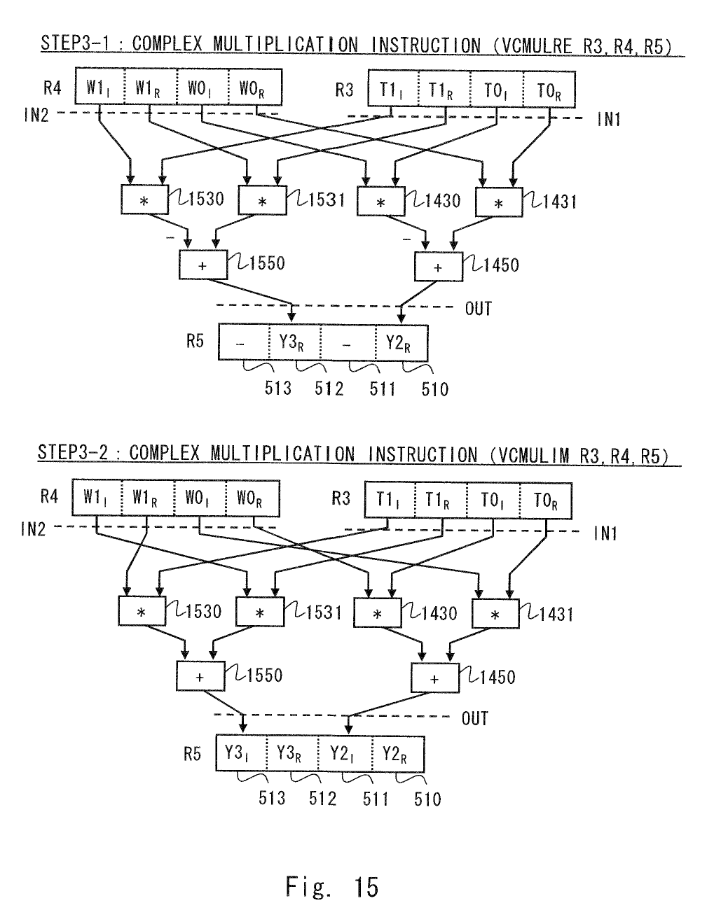

Next, it is explained that the execution procedure of butterfly computations shown in FIG. 4 executed by the complex operation unit 240 shown in FIG. 12 and the complex operation unit 250 having the same structure as the complex operation unit 240. FIGS. 14 and 15 show equivalent diagrams of the STEPs 1-3 shown in FIG. 4, redrawn with specific components of the complex operation units 240 and 250.

The execution of the STEP 1 by the addition instruction (VADDS instruction) and the execution of the STEP 2 by the subtraction instruction (VSUBS instruction) shown in FIG. 14 are same as those steps carried out by the instruction execution portion 14 in accordance with the first embodiment shown in FIG. 7.

Meanwhile, the execution of the STEP 3 by two instructions shown in FIG. 15, namely, VCMULRE and VCMULIM instructions is different from the step carried out by the instruction execution portion 14 shown in FIG. 7. The VCMULRE instruction is an instruction to instruct the execution of MADD operations to calculate the real parts of the complex multiplication results Y2 and Y3, and the VCMULIM instruction is an instruction to instruct the execution of MADD operations to calculate the imaginary parts of the complex multiplication results Y2 and Y3. That is, the instruction execution portion 24 performs two complex multiplications by carrying out two successive MADD operations in response to the two instructions, i.e., the VCMULRE and VCMULIM instructions. In the example shown in FIG. 15, the instruction execution portion 24 performs MADD operations in response to the VCMULRE instruction in STEP 3-1, and produces the real parts of Y2 and Y3. Furthermore, the instruction execution portion 24 performs MADD operations in response to the VCMULIM instruction in STEP 3-2, and produces the imaginary parts of Y2 and Y3.

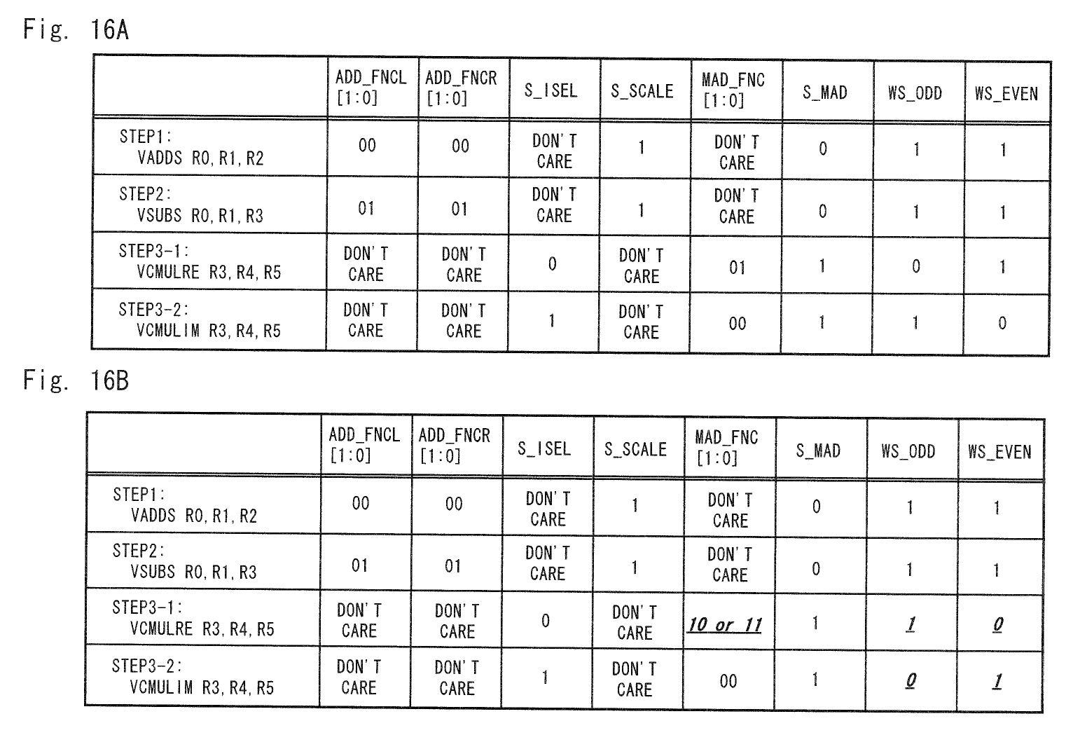

In the execution processes of STEPs 1-3 shown in FIGS. 14 and 15, the operations of the plural ADD/SUBs and plural selectors contained in the complex operation units 240 and 250 are controlled by the control signals supplied from the control portion 22. Furthermore, the operation of the data select circuit 26 is also controlled by the control portion 22. A table in FIG. 16A shows combinations of the control signals supplied from the control portion 22 to the instruction execution portion 24 and the data select circuit 26 when each of the VADDS, VSUBS, VCMULRE, and VCMULIM instructions shown in FIGS. 14 and 15 is decoded.

For example, when the VADDS instruction is decoded in the STEP 1, both of the control signal AD_FNCL[1:0] to the ADD/SUBs 1400 and 1500 and the control signal AD_FNCR[1:0] to the ADD/SUBs 1401 and 1501 are set to “00”. In addition, a control signal S_SCALE, which indicates the scaling to the addition result, is set to “1”. Furthermore, both control signals S_ODD and S_EVEN to the data select circuit 26 are set to “1” in order to store all of the 64-bit data OUT[0]-[3] outputted from the instruction execution portion 24 in the register R2.

Furthermore, when the VCMULRE instruction is decoded in the STEP 3-1, the control signal I_SEL to the selectors 2400 and 2401 is set to “0”, and necessary data for the calculation of the real part Y2_{R} of Y2 are supplied to the multipliers 1430 and 1431. Incidentally, two selectors corresponding to the selectors 2400 and 2401 in the complex operation unit 250 operate in response to the control signal I_SEL in a similar manner to the selectors 2400 and 2401, and supply necessary data for the calculation of the real part Y3_{R} of Y3 to the multipliers 1530 and 1531.

Furthermore, since the control signal S_MAD is set to “1”, both of OUT[0] and [1] become the real part Y2_{R} of Y2 in STEP 3-1. Similarly, both of OUT[2] and [3] become the real part Y3_{R} of Y3. Furthermore, since the control signal S_ODD to the data select circuit 26 is set to “0” and the control signal S_EVEN is set to “1”, the real part Y2_{R} of Y2 is stored in the lowest 16-bit area 510 of the register R5 and the real part Y3_{R} of Y3 is stored in the 16-bit area 512 of the register R5.

On the other hand, in STEP 3-2, since the control signal S_MAD is set to “1”, both of OUT[0] and [1] become the imaginary part Y2, of Y2. Similarly, both of OUT[2] and [3] become the imaginary part Y3, of Y3. Furthermore, since the control signal S_ODD to the data select circuit 26 is set to “1” and the control signal S_EVEN is set to “0”, the imaginary part Y2_{I} of Y2 is stored in the 16-bit area 511 of the register R5 and the imaginary part Y3_{I} of Y3 is stored in the 16-bit area 513 of the register R5. That is, the storage orders of the real parts and imaginary parts of the complex multiplication results Y2 and Y3 in the register R5 becomes the same as the storage orders of the real parts and imaginary parts of the target data T0, T1, W0, and W1 of the complex multiplications stored in the registers R3 and R4.

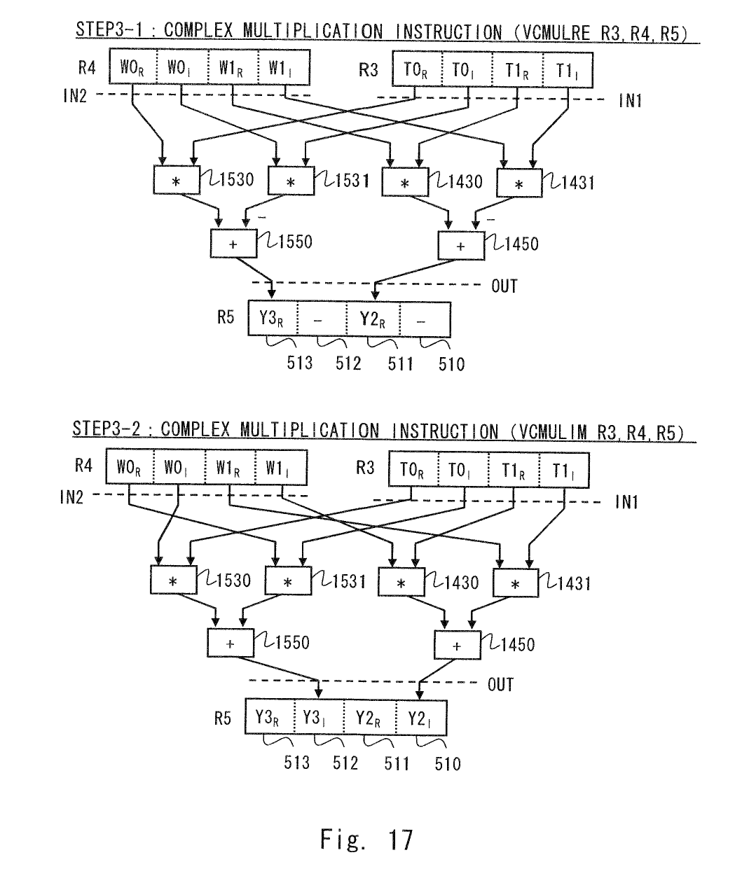

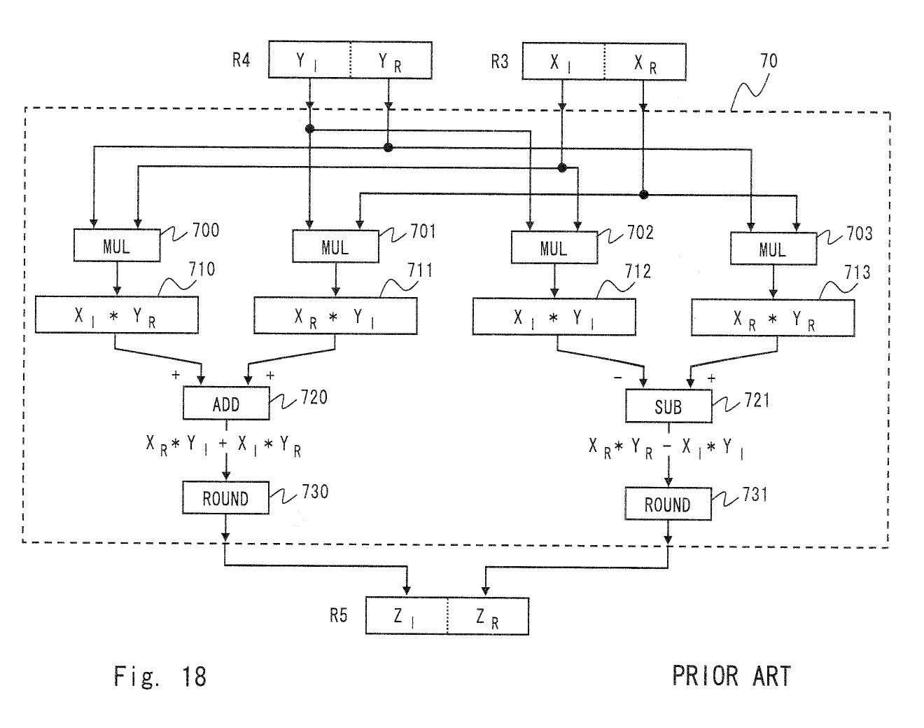

Next, FIG. 17 shows another execution procedure of the STEPs 3-1 and 3-2, in which the storage orders of the real parts and imaginary parts of X0-X3 in the register R0 and R1 are opposite to the storage orders shown in FIG. 7.

The directions of the subtractions that are carried out when the complex multiplication instruction (VCMULRE instruction) is executed in the STEP 3-1 are different between the example shown in FIG. 15 and the example shown in FIG. 17. Furthermore, the output destinations of the real part Y2_{R} of Y2 and the real part Y3_{R} of Y3 from the data select circuit 26 are different between the example shown in FIG. 15 and the example shown in FIG. 17. That is, the real part Y2_{R} of Y2 is stored in the 16-bit area 511 of the register R5, and the real part Y3_{R} of Y3 is stored in the highest 16-bit area 513 of the register R5 in FIG. 17.

Furthermore, the output destinations of the imaginary part Y2_{I} of Y2 and the imaginary part Y3_{I} of Y3 from the data select circuit 26 in the execution of the complex multiplication instruction (VCMULIM instruction) in the STEP 3-2 are different between the example shown in FIG. 15 and the example shown in FIG. 17. That is, the imaginary part Y2_{I} of Y2 is stored in the lowest 16-bit area 510 of the register R5, and the imaginary part Y3_{I} of Y3 is stored in the 16-bit area 512 of the register R5 in FIG. 17.

A table in FIG. 16B shows combinations of the control signals supplied from the control portion 22 to the instruction execution portion 24 and the data select circuit 26 when each of the VCMULRE and VCMULIM instructions shown in FIG. 17 is decoded. When the VCMULRE instruction is decoded In the STEP 3-1, a control signal MAD_FNC[1:0] to the ADD/SUB 1450 is set to “10” or “11”, and control signals S_ODD and S_EVEN to the data select circuit 26 are set to “1” and “0” respectively. Meanwhile, the VCMULIM instruction is decoded in the STEP 3-2, a control signal S_ISEL to the selectors 2400 and 2401 is set to “1”, and control signals S_ODD and S_EVEN to the data select circuit 26 are set to “0” and “1” respectively.

In this manner, the control portion 22 can conform the storage orders of the real parts and imaginary parts of the complex multiplication results Y2 and Y3 in the register R5 with the storage orders of the real parts and imaginary parts of the target data X0-X3 of the butterfly computation in the registers R0 and R1 by controlling the operations of the data select circuit 26. That is, similarly to the above-mentioned microprocessor 1, the microprocessor 2 can determine the data storage positions of the real parts and imaginary parts of the complex multiplication result data Y1-Y4 such that the storage orders of the real parts and imaginary parts of the complex multiplication result data Y1-Y4 conform with the storage orders of the real parts and imaginary parts of the target data X0-X3 of the complex operation, even if the storage orders of the real parts and imaginary parts of the target data X0-X3 of the complex operation in the data memory 51 or the register file 13 are changed.

Therefore, similarly to the microprocessor 1, the restrictions on the hardware for the storage orders of the real parts and imaginary parts of input complex number data are minimized, and there is no need for the redundant processing necessary to reverse the storage order of the real part and imaginary part in the microprocessor 2. Furthermore, it can minimize the increase in redundancy brought in the software by the processing necessary to reverse the array order of the real part and imaginary part.

Incidentally, specific embodiments in which the microprocessor 1 and microprocessor 2 performs DIF-type butterfly computations are explained in the first and second embodiments of the present invention. However, the DIF-type butterfly computations are merely one example of complex operations including complex multiplications. For example, the microprocessor 1 and microprocessor 2 may perform Decimation-In-Time (DIT) type butterfly computations.

Furthermore, configurations in which the instruction memory 50 and data memory 51 are located on the outside of the microprocessor 1 and microprocessor 2 are illustrated in the first and second embodiments. However, for example, a single chip microprocessor having either or both of the instruction memory 50 and data memory 51 integrated in the chip may be used as a substitute for the microprocessor 1 or microprocessor 2. That is, the present invention is not limited to the specific implementation shown in FIG. 1, and may be applied to microprocessors in forms of various implementations.

It is apparent that the present invention is not limited to the above embodiments, but may be modified and changed without departing from the scope and spirit of the invention.

What is claimed is:

1. A microprocessor comprising:
an instruction decode portion to decode instructions;
a register file including a plurality of registers;
a complex operation unit to perform complex operation including complex multiplication by using first and second complex number data supplied from the register file based on an instruction decoded by the instruction decode portion, the a complex operation unit outputting the result of the complex operation toward the register file; and
a data storage position determining means for determining storage positions of a real part and an imaginary part of output data of the complex operation unit in the register file such that the storage order of the real part and the imaginary part of the output data in the register file is consistent with storage orders of real parts and imaginary parts of the first and second complex number data.

2. A microprocessor comprising:
an instruction decode portion to decode instructions;
a register file including first to third registers, the first register being able to store a real part and an imaginary part of a first complex number data, and the second register being able to store a real part and an imaginary part of a second complex number data in the same order as the first register; and
a complex operation unit to perform complex operation by using the first and second complex number data supplied from the register file based on an instruction decoded by the instruction decode portion, the complex operation unit outputting the result of the complex operation toward the third register;
wherein the complex operation unit including:
a complex multiplier adopted to perform complex multiplication by first and second Multiply-Add (MADD) operation circuits, each of the first and second MADD operation circuits being able to carry out a MADD operations; and
a first select circuit adopted to change an output destination of each of the first and second MADD operation circuits between a first area and a second area adjacent to the first area of the third register.

3. The microprocessor according to claim 2, wherein the first MADD operation circuit carries out multiplication of a first half portion of the first complex number data supplied from the first register and a second half portion of the second complex number data supplied from the second register, multiplication of a second half portion of the first complex number data and a first half portion of the second complex number data, and addition or subtraction of the results of these two multiplications; and
the second MADD operation circuit carries out multiplication of the first half portions of the first and second complex number data, multiplication of the second half portions of the first and second complex number data, and addition or subtraction of the results of these two multiplications.

4. The microprocessor according to claim 2, wherein the complex operation unit comprises a first output terminal to output data to the first area of the third register and a second output terminal to output data to the second area; and
wherein the first select circuit is capable of interchanging connecting relations of the first and second MADD operation circuits to the first and second output terminals.

5. The microprocessor according to claim 3, wherein the complex operation unit comprises a first output terminal to output data to the first area of the third register and a second output terminal to output data to the second area; and
wherein the first select circuit is capable of interchanging connecting relations of the first and second MADD operation circuits to the first and second output terminals.

6. The microprocessor according to claim 2, wherein the complex operation unit further includes an adder-subtractor capable of complex addition or complex subtraction; and
a second select circuit being provided on the output side of the complex multiplier and the adder-subtractor, wherein
the first and second complex number data are supplied in parallel from the first and second registers to the complex multiplier and the adder-subtractor, and
the second select circuit operates based on an instruction decoded by the instruction decode portion, and selects and outputs output data of the complex multiplier when the decoded instruction is a complex multiplication instruction and selects and outputs output data of the adder-subtractor when the decoded instruction is an instruction to carry out a complex addition or a complex subtraction.

7. The microprocessor according to claim 3, wherein the complex operation unit further includes an adder-subtractor capable of complex addition or complex subtraction; and
a second select circuit being provided on the output side of the complex multiplier and the adder-subtractor, wherein
the first and second complex number data are supplied in parallel from the first and second registers to the complex multiplier and the adder-subtractor, and
the second select circuit operates based on an instruction decoded by the instruction decode portion, and selects and outputs output data of the complex multiplier when the decoded instruction is a complex multiplication instruction and selects and outputs output data of the adder-subtractor when the decoded instruction is an instruction to carry out a complex addition or a complex subtraction.

8. The microprocessor according to claim 4, wherein the complex operation unit further includes an adder-subtractor capable of complex addition or complex subtraction; and
a second select circuit being provided on the output side of the complex multiplier and the adder-subtractor, wherein
the first and second complex number data are supplied in parallel from the first and second registers to the complex multiplier and the adder-subtractor, and
the second select circuit operates based on an instruction decoded by the instruction decode portion, and selects and outputs output data of the complex multiplier when the decoded instruction is a complex multiplication instruction and selects and outputs output data of the adder-subtractor when the decoded instruction is an instruction to carry out a complex addition or a complex subtraction.

9. The microprocessor according to claim 5, wherein the complex operation unit further includes an adder-subtractor capable of complex addition or complex subtraction; and
a second select circuit being provided on the output side of the complex multiplier and the adder-subtractor, wherein
the first and second complex number data are supplied in parallel from the first and second registers to the complex multiplier and the adder-subtractor, and
the second select circuit operates based on an instruction decoded by the instruction decode portion, and selects and outputs output data of the complex multiplier when the decoded instruction is a complex multiplication instruction and selects and outputs output data of the adder-subtractor when the decoded instruction is an instruction to carry out a complex addition or a complex subtraction.

10. A microprocessor comprising:
an instruction decode portion to decode instructions;
a register file including first to third registers, the first register being able to store a real part and an imaginary part of a first complex number data, and the second register being able to store a real part and an imaginary part of a second complex number data in the same order as the first register;
a complex operation unit to perform complex operation by using the complex number data supplied from the register file based on an instruction decoded by the instruction decode portion, the complex operation unit outputting the result of the complex operation toward the third register;
a storage area select circuit to change a storage destination of output data of the complex operation unit between a first area and a second area adjacent to the first area of the third register; and
a control circuit adopted to control the operation of the storage area select circuit;
wherein the complex operation unit includes:
a Multiply-Add (MADD) operation circuit; and
an input select circuit to change a combination of data input to the MADD operation circuit;
wherein the MADD operation circuit can select by the switching operation of the input select circuit:
a first operation state where multiplication of a first half portion of the first complex number data supplied from the first register and a second half portion of the second complex number data supplied from the second register, multiplication of a second half portion of the first complex number data and a first half portion of the second complex number data, and addition or subtraction of the results of these two multiplications are carried out; or
a second operation state where multiplication of the first half portions of the first and second complex number data, multiplication of the second half portions of the first and second complex number data, and addition or subtraction of the results of these two multiplications are carried out; and
wherein the control circuit changes states of the input select circuit and the storage area select circuit in unison in response to an instruction decoded in the instruction decode portion.

11. The microprocessor according to claim 10, wherein:
when a first MADD instruction is decoded, the input select circuit is operated such that the MADD operation circuit is brought to the first operation state and the storage area select circuit is operated such that the first area becomes a storage destination of output data of the complex operation unit; and
when a second MADD instruction different from the first MADD instruction is decoded, the input select circuit is operated such that the MADD operation circuit is brought to the second operation state and the storage area select circuit is operated such that the second area becomes the storage destination of the output data of the complex operation unit.

12. The microprocessor according to claim 10, wherein the complex operation unit further includes an adder-subtractor capable of complex addition or complex subtraction; and
a second select circuit being provided on the output side of the MADD operation circuit and the adder-subtractor, wherein
the first and second complex number data are supplied in parallel from the first and second source registers to the MADD operation circuit and the adder-subtractor, and
the second select circuit operates based on an instruction decoded by the instruction decode portion, and selects and outputs output data of the MADD operation circuit when the decoded instruction is a MADD operation instruction and selects and outputs output data of the adder-subtractor when the decoded instruction is an instruction to carry out a complex addition or a complex subtraction.

13. The microprocessor according to claim 11, wherein the complex operation unit further includes an adder-subtractor capable of complex addition or complex subtraction; and
a second select circuit being provided on the output side of the MADD operation circuit and the adder-subtractor, wherein
the first and second complex number data are supplied in parallel from the first and second source registers to the MADD operation circuit and the adder-subtractor, and
the second select circuit operates based on an instruction decoded by the instruction decode portion, and selects and outputs output data of the MADD operation circuit when the decoded instruction is a MADD operation instruction and selects and outputs output data of the adder-subtractor when the decoded instruction is an instruction to carry out a complex addition or a complex subtraction.
